(19) United States
(12) Patent Application Publication
(10) Pub. No.: US 2024/0054544 A1
(43) Pub. Date: Feb. 15, 2024

(54) INFORMATION DISPLAY METHOD AND APPARATUS, AND ELECTRONIC DEVICE

(71) Applicant: BEIJING ZITIAO NETWORK TECHNOLOGY CO., LTD., Beijing (CN)

(72) Inventor: Qing ZENG, Beijing (CN)

(21) Appl. No.: 18/260,871

(22) PCT Filed: Jan. 18, 2022
(86) PCT No.: PCT/CN2022/072474

§ 371 Date: Jul. 10, 2023

(30) Foreign Application Priority Data
Jan. 11, 2021 (CN) 202110032984.1

(51) Int. Cl. G06Q 30/0601

(52) U.S. Cl. CPC G06Q 30/0625

(57) ABSTRACT

Disclosed are an information display method and apparatus, and an electronic device. A specific mode of implementation of the method comprises: acquiring item information of a target user from at least one document, wherein the item information of the target user comprises an item for which the target user is a creator and/or an executor; and displaying the acquired item information on an associated page of the current page of the document or in a preset area of the current page thereof. Thus, a new information display method is provided.

### CROSS REFERENCE OF RELATED APPLICATION

The present application is the national phase of International Patent Application No. PCT/CN2022/072474, titled “INFORMATION DISPLAY METHOD AND APPARATUS, AND ELECTRONIC DEVICE”, filed on Jan. 18, 2022, which claims priority to Chinese Patent Application No. 202110032984.1, titled “INFORMATION DISPLAY METHOD AND APPARATUS, AND ELECTRONIC DEVICE”, filed on Jan. 11, 2021 with the China National Intellectual Property Administration, all of which are incorporated herein by reference in their entireties.

### FIELD

The present disclosure relates to the technical field of the Internet, and in particular to a method and an apparatus for displaying information, as well as an electronic device.

### BACKGROUND

With the development of the Internet, increasing users use terminal devices to implement various functions. For example, users record their items to be deal with through electronic devices. In some scenarios, users co-edit documents with other users, thereby sharing information between users.

### SUMMARY

This summary is provided to introduce concepts in a simplified form. These concepts will be described in detail in the following detailed description. This summary is neither intended to identify key features or essential features of the claimed technical solution, nor intended to limit the scope of the claimed technical solution.

In a first aspect, a method for displaying information is provided according to an embodiment of the present disclosure. The method includes: acquiring item information of a target user from at least one document, where the item information of the target user includes an item for which the target user is a creator and/or executor; and displaying the acquired item information on an associated page of a current page of the document or in a preset area on a current page.

In a second aspect, an apparatus for displaying information is provided according to an embodiment of the present disclosure. The apparatus includes: an acquisition unit and a display unit. The acquisition unit is configured to acquire item information of a target user from at least one document, where the item information of the target user includes an item for which the target user is a creator and/or executor. The display unit is configured to display the acquired item information on an associated page of a current page of the document or in a preset area on a current page.

In a third aspect, an electronic device is provided according to an embodiment of the present disclosure. The electronic device includes one or more processors and a storage device. The storage device is configured to store one or more programs that, when being executed by the one or more processor, implement the method for displaying information in the first aspect.

In a fourth aspect, a computer-readable storage medium is provided according to an embodiment of the present disclosure. The computer-readable storage medium stores computer programs that, when being executed by a processor, implement the method for displaying information in the first aspect.

With the method and the apparatus for displaying information, and the electronic device according to the embodiments of the present disclosure, item information of a target user is acquired from at least one document. The item information of the target user includes an item created by the target user and/or an item for which the target user is an executor. Further, the item information of the target user is displayed. Therefore, item information scattered in various documents can be automatically collected, reducing the time spent by the user on sorting out the item information. It is convenient for users to view their own item information, so that the user can deal with an item in time, thereby improving the efficiency of the user in acquiring information and dealing with items.

### BRIEF DESCRIPTION OF THE DRAWINGS

The above and other features, advantages and aspects of the various embodiments of the present disclosure will become more apparent with reference to the following detailed description in conjunction with the drawings. Throughout the drawings, the same or similar reference numerals denote the same or similar elements. It should be understood that the drawings are schematic and that components and elements are not necessarily drawn to scale.

FIG. 1 is a schematic flowchart illustrating a method for displaying information according to an embodiment of the present disclosure;

FIG. 2 is a schematic diagram illustrating an application scenario of the method for displaying information according to an embodiment of the present disclosure.

FIG. 3 is a schematic structural diagram illustrating an apparatus for displaying information according to an embodiment of the present disclosure;

FIG. 4 is a schematic structural diagram illustrating a system architecture to which the method for displaying information according to the embodiment of the present disclosure is applicable; and

FIG. 5 is a schematic structural diagram illustrating an electronic device according to an embodiment of the present disclosure.

### DETAILED DESCRIPTION

Embodiments of the present disclosure will be described in more detail below with reference to the drawings. Although some embodiments of the present disclosure are shown in the drawings, it should be understood that the present disclosure may be embodied in various forms and should not be construed as limited to the embodiments set forth herein. Instead, these embodiments are provided so that the understanding of the present disclosure can be thorough and complete. It should be understood that the drawings and embodiments of the present disclosure are for illustrative purposes only, and are not intended to limit the protection scope of the present disclosure.

It should be understood that the various steps described in the method embodiments of the present disclosure may be performed in different orders, and/or performed in parallel. Additionally, the method embodiments may include additional steps and/or illustrated steps may be not performed. The scope of the present disclosure is not limited in this regard.

The term “comprising” and its variations herein are non-exclusive, i.e., “including but not limited to”. The term “based on” means “based at least in part on”. The term “one embodiment” means “at least one embodiment.” The term “another embodiment” means “at least one further embodiment”. The term “some embodiments” means “at least some embodiments.” Relevant definitions of other terms will be given in the description below.

It should be noted that concepts such as “first” and “second” mentioned herein are only for distinguishing different devices, modules or units, rather than limiting the sequence or interdependence of functions performed by these devices, modules or units.

It should be noted that the determiners of “a” and “a plurality” mentioned in the present disclosure are illustrative rather than restrictive. Those skilled in the art should understand that, unless the context clearly indicates otherwise, such determiners should be understood as “one or more”.

The names of messages or information exchanged between multiple devices in the embodiments of the present disclosure are used for illustrative purposes only, and are not used to limit the scope of these messages or information.

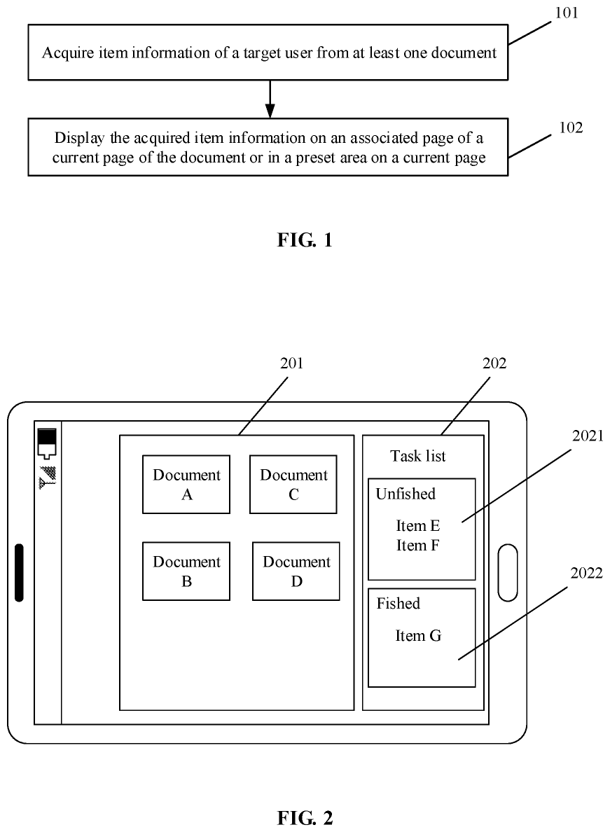

FIG. 1 is a flowchart illustrating a method for displaying information according to an embodiment of the present disclosure. The method shown in FIG. 1 includes the following steps S101 to S102.

In step S101, item information of a target user is acquired from at least one document.

In this embodiment, the execution body of the method for displaying information (e.g., including a server and/or a terminal device) may acquire the item information of the target user from at least one document.

In this embodiment, the item information of the target user may include at least one of but not limited to: an item with the target user as a creator, and an item with the target user as an executor.

In this embodiment, the at least one document may be a document of any content or format. The number of documents may be one or at least two. For example, the at least one document may include a document in a document space, and may also include a document in a folder specified by a user. The document space may be a cloud space recording documents from multiple users.

In this embodiment, the target user may be any user. The target user is used herein for the convenience of description and does not constitute a limitation to the user.

In this embodiment, the item with the target user as the creator may be an item created by the target user.

In this embodiment, the item with the target user as the executor may be an item created by the target user or another user and assigned to the target user.

In this embodiment, the item information may indicate an item. For example, the item information may include partial information in the item so as to indicate the item. The item may record matters to be dealt with. In some application scenarios, the item may also be called a to do item.

In step 102, the acquired item information is displayed on an associated page of a current page of the document or in a preset area on a current page.

In this embodiment, the acquired item information may be displayed on the associated page of the current page of the at least one document or in the preset area on the current page.

Here, where and how the item information is displayed depend on actual application conditions, and thus are not limited herein.

Here, the associated page may be a page form which the document is accessible or openable.

For example, the associated page may be a display page in a document space. The document space may be a cloud space recording documents of multiple users. The associated page may also include an interface including access information about the document, for displaying the access information about the document.

Here, the preset area on the current page may include any position in the current page, for example, a right area or left area of the current page.

It should be noted that with the method for displaying information according to the embodiments of the present disclosure, item information of the target user is acquired from at least one document. The item information of the target user includes item information created by the target user and/or an item for which the target user is an executor. Further, the item information of the target user is displayed on the associated page of the document or in the preset area on the current page. Therefore, item information scattered in various documents can be automatically collected, reducing the time spent by the user on sorting out the item information. It is convenient for users to view their own item information on the associated page or the current page where the information is gathered, so that the user can deal with the item in time, thereby improving the efficiency of the user in acquiring information and dealing with the item.

In some related technologies, in contrast, it is difficult to know the progress of all item information after an item information distributor sets and distributes the item information. An item information executor fails to be promptly reminded of the process of a single piece of item information after receiving the assigned item information. The single piece of item information, if not dealt with immediately, is likely to be forgotten. Sometimes it is also difficult to find the document for originally assigning the item information to feed back that the assigned item information has been finished after the item information is finished. It is difficult for the item information executor, when receiving multiple pieces of item information, to clearly know which item information has been finished and which item information is to be deal with. Therefore, according to the method for displaying information in this embodiment, the item information with the target user as the creator and/or executor can be displayed in a centralized manner, thereby improving the efficiency of the user in acquiring information and dealing with the item.

For example, reference is made to FIG. 2, which shows a scenario to which some embodiments of the present application are applicable.

The interface displayed on a screen in FIG. 2 may be an interface for displaying a document space. This interface may include a document display area 201 and a task list display area 202. In the document display area, document access information is displayed. The document display area 201 in FIG. 2 displays document access information including “document A”, “document B”, “document C” and “document D”. The task list display area in FIG. 2 includes a first display area 2021 and a second display area 2022.

For example, the first display area may display unfinished item information, e.g., item information E and item information F.

For example, the second display area 2022 may display finished item information, e.g., item information G

For example, the item information E may be recorded in a document A, the item information F may be recorded in a document B, and the item information G may be recorded in a document D.

In some embodiments, step 101 may include: determining, in response to detection of a first item creation operation performed by the target user in the document, item information created through the first item creation operation as the item information of the target user.

Here, the first item creation operation may be used to create an item. The first item creation operation may be performed by the target user. The target user may perform a predefined item creation operation in the document to create the item information. Details about the predefined item creation operation depend on the actual application scenarios. For example, an item creation interface (e.g., inserting a task list) may be invoked in the document to create an item.

It should be noted that the target user can quickly create the item information through the first item creation operation.

In some embodiments, step 101 may include: determining, in response to detection of a second item creation operation with the target user as the executor in the document, item information created through the second item creation operation as the item information of the target user.

Here, the second item creation operation is used to create an item. The second item creation operation may be performed by any user. The executor of the item created through the second item creation operation may be the target user. During the execution of the second item creation operation, the creator may assign tasks and specify task executors while assigning the tasks. For example, a user may be selected by a specified character (e.g., @) so as to set the user as the executor of the tasks.

It should be noted that tasks may be assigned through the second item creation operation. Thus, the target user as the executor can quickly obtain own item information.

In some embodiments, step 101 may include: searching for the item information of the target user from item information recorded in a document to be searched; and acquiring the found item information of the target user.

Here, the document to be searched may include at least one of: a text document and a table document.

Here, the item information recorded in the document to be searched includes at least one of: item information recorded in text of the text document, item information recorded in a table inserted in the text document, and item information recorded in a cell of the table document.

For example, the item information recorded in the document to be searched may include an identifier of the creator and/or an identifier of the executor. By comparing an identifier of the target user with the identifier of each creator in the document to be searched, the item information whose creator is the target user is found. By comparing the identifier of the target user with the identifier of each executor in the document to be searched, the item information with the target user as the executor is found.

It should be noted that, the item information of the target user is found from the document to be searched, to obtain as complete item information as possible, thereby improving the accuracy of the acquired item information of the user.

In some embodiments, the associated page includes a page for displaying document access information of the target user.

In some embodiments, step 102 may include: displaying the acquired item information on the page for displaying the document access information of the target user.

Here, the document access information of the target user may be used to indicate the document, and the document may be displayed in response to a trigger operation performed by the user.

It should be noted that the item information of the target user is displayed on a document information display page of the target user, so that the target user, when viewing the document information, can be provided with the item information, reminded of items to be deal with and provided with a guidance on dealing with the document. Therefore, it is unnecessary for the user to search a wide range of documents, thereby improving the efficiency of the user in acquiring information and dealing with the item.

In some embodiments, step 102 may include: determining due item information that expires within a preset time period according to an item deadline and a current time; and indicating the due item information among the displayed item information by predefined indication information.

Here, the item information may have an item deadline. The item deadline may be used to indicate a time instant by which the item information should be finished.

Here, the preset time period may be a period of time starting from the current time.

For example, it is now 0:00 on Jan. 1, 2021, and the preset time period may be one day starting from 0:00 on Jan. 1, 2021, i.e., the whole day of Jan. 1, 2021. Item information whose deadline is within the whole day of Jan. 1, 2021 may be determined as the due item information.

Here, the predefined indication information may be used to indicate that the item information is due item information.

For example, if the preset time period indicates the same date as the current time, then the due item information may be referred to as item information due today. In this case, the item information may be marked with the words “due today”, so as to remind the user that the item information is due today. Alternatively, the item information due today and its deadline may be highlighted in a color (e.g., red), so as to remind the user that the item information is due today.

It should be noted that the due item information is determined and the indication information of the due item information is displayed, so that the user can be reminded of a more urgent item at present, thereby preventing the user from missing the urgent item.

Here, the number of the due item information may also be displayed. The number of the due item information may be the number of the determined due item information.

In some application scenarios, the item information may be displayed by clicking an item information display control. The number of the due item information may be displayed in response to detection of a hover operation on the item information display control. For example, the words “There are 5 items due today” may be displayed.

It should be noted that the due item information is determined and the number of the due item information is displayed, so that the user can be intuitively reminded of the number of more urgent items, which provides a basis for the user to reasonably arrange the handling of items. Therefore, the overall efficiency of the user in dealing with the items can be improved.

In some embodiments, the method may further include: displaying, in response to a document access operation, a page of the document indicated by the document access operation; acquiring item information of the document indicated by the document access operation, where the item information includes an item for which any user is the executor and/or creator; and displaying the item information of the document indicated by the document access operation on a current page of the accessed document.

Here, the document access operation may include, but is not limited to, at least one of: an operation of starting a document from a document access, and a toggle display operation. For example, the toggle display operation may indicate the following case. The document A and the document B are both open. The user selects the document A, and then moves the cursor to the document B, so that the document B is selected. The document indicated by the document access operation may be understood as the selected document.

Here, the selected document may be referred to as the current document. At least one piece of item information may be included in the current document. The item information in the current document may be referred to as the current document item information in order to be distinguished from another item information herein. It can be understood that the current document item information may or may not be the item information of the target user.

It should be noted that as the user switches between the page of the selected document A and the page of the selected document B, the area displaying the current document item information also quickly change the content of the displayed item information (that is, switches between the item information in the document A and the item information in the document B).

It should be noted that the current document item information may be displayed when the user accesses the document, so as to display the item information in the document to the user in a timely manner. In this way, the item information involved in the document can be presented to the user in a concentrated manner, thereby preventing the user from turning pages in order to searching for information by himself. No user operation is involved, thus avoiding the consumption of computing resources caused by user operations.

In some application scenarios, the current document item information is displayed in an item information display column.

In some embodiments, step 102 may include: displaying the item information of the target user in at least one item information display column.

Here, the item information display column may be understood as an area where item information is displayed together. For each item information display column, the category of item information displayed therein may be predefined.

It should be noted that the item information may be orderly displayed to the user in columns according to categories, thereby improving the efficiency for the user to obtain information related to the item information.

In some embodiments, the item information display column may include at least one of: a first display column, a second display column, and a third display column.

Here, the first display column may be used to display the item information with the target user as the creator. The second display column may be used to display the item information with the target user as the executor. The third display column may be used to display the item information of the target user.

In some embodiments, in the above step, the displaying the item information of the target user in at least one item information display column may include at least one of but not limited to: displaying the item information with the target user as the creator in the first display column; displaying the item information with the target user as the executor in the second display column; and displaying the item information of the target user in the third display column.

Optionally, the item information of the document indicated by the document access operation may be displayed on the document interface or on the page where the document is located. For example, the item information of the accessed document is displayed in a fourth display column.

In some embodiments, the method further includes: displaying item creation prompt information in response to determination that there is no corresponding item information that is to be displayed in the item information display column.

For example, the item information corresponding to the first display column is item information whose creator is the target user. A case that there is no item information whose creator is the target user in the at least one document may be understood that there is no corresponding item information that is to be displayed in the first display column.

It should be noted that the item creation prompt information is displayed so as to remind the user to create item information, thereby improving the efficiency of information management and preventing the users from missing items to be dealt with.

In some embodiments, each of the item information display columns may include at least one sub-column. The sub-column included in the item information display column may include at least one of but not limited to: an unfinished sub-column and a finished sub-column.

In some embodiments, the method may further include: switching a display state of the sub-column in response to detection of a display state switch operation for the sub-column. The display state of the sub-column includes an expanded state and a collapsed state.

In some embodiments, the method further includes: displaying the sub-column in the expanded state indicated by a last display state switch operation by the target user.

In some embodiments, the method further includes: displaying, in the sub-column, the number of items to be dealt with displayed in the sub-column.

In some embodiments, the unfinished sub-column has a sub-column prompt control. The sub-column prompt control responds to the display state switch operation. The method further includes: constantly displaying the sub-column prompt control in a pending item display column in response to update of an item to be dealt with in the pending item display column.

In some embodiments, step 102 includes: displaying item information in a first state in a first display area; and displaying item information in a second state in a second display area.

In some application scenarios, a display area may be arranged in a display interface (for example, a display interface in a document space) to display the acquired item information. The display area may include the first display area and the second display area. The first display area is used to display the item information in the first state. The second display area may be used to display the item information in the second state.

In some application scenarios, the first display area may be understood as the unfinished sub-column. The second display area may be understood as the finished sub-column.

Here, the state of the item information may be classified according to actual application scenarios, which is not limited herein. For example, item information may be classified according to the degree of completion.

In some embodiments, the item information in the first state may be the unfinished item information. The item information in the second state may be the finished item information.

It should be noted that item information in different states is displayed in respective display areas, thereby providing the target user with a display area for clearly displaying item information in a single state. Therefore, the target user can quickly acquire item information in different states so as to locate item information in a desired state, thereby improving the efficiency of information acquisition for the target user.

In some embodiments, an order in which the item information is displayed in the first display area may be determined through a first order determination step.

In some embodiments, the first order determination step may include: determining, based on first time information associated with the item information in the first state, an order in which the item information in the first state is to be displayed.

Here, the item information in the first state may be associated with the first time information. It can be understood that there is no associated time, and it may also be understood as a kind of time information. The category of time included in the first time information may depend on actual application scenarios.

It should be noted that the order of displaying the item information in the first state is determined based on the first time information, so that the item information in the first state can be displayed in order. In this way, the efficiency of the target user in acquiring or dealing with the item information in the first state can be improved.

In some embodiments, content indicated by the first time information includes at least one of: a null value or a time point.

In some embodiments, the time point included in the first time information may be a deadline of the item information in the first state.

In some embodiments, the determining, based on first time information associated with the item information in the first state, an order in which the item information in the first state is to be displayed includes: determining, based on the content indicated by the first time information, a category that the item information in the first state falls into, where the category that the item information in the first state falls into includes at least one of: a null category and a time point category; generating a queue of the item information in the first state; and determining, based on the queue of the item information in the first state, the order in which the item information in the first state is to be displayed.

Here, in the queue of the item information in the first state, the item information of the time point category is ranked before the item information of the null category.

In other words, if the first time information associated with the item information in the first state indicates a null value, then the item information in the first state may be called item information of the null category in the first state. If the first time information associated with the item information in the first state indicates a time point, then the item information in the first state may be referred to as item information of the time point category in the first state.

In the generated queue of the item information in the first state, the item information of the time point category may precede the item information of the null category.

It should be noted that the item information of the time point category is ranked before the item information of the null category in the first state, so that the user can obtain the item information of the time point category in the first state as much as possible first when viewing the item information in the first state. Therefore, the order of displaying the item information in the first state can be automatically set according to urgency of the item information in the first state, so that the user can view and deal with the item information in the first state according to the urgency.

In some embodiments, the generating a queue of the item information in the first state includes: determining, based on a time point indicated by the first time information associated with the item information in the first state, a ranking of the item information of the time point category in the queue of the item information in the first state.

Here, among the item information of the time point category in the first state, the order of displaying the item information of the time point category in the first state may be determined according to the time point indicated by the first time information associated with the item information in the first state.

It should be noted that the order is determined based on the associated time point, so that the item information of the time point category in the first state can be displayed orderly. Therefore, the efficiency for the user to view and deal with the item information of the time point category in the first state according to the time point is improved.

The order in which the item information in the second state is to be displayed in the second display area is determined through a second order determination step.

In some embodiments, the second order determination step may include: determining, based on second time information associated with the item information in the second state, the order in which the item information in the second state is to be displayed.

Here, the second time information associated with the item information in the second state may include various time items. The specific time item on which the sorting is based may be performed according to actual application scenarios.

In some embodiments, the second time information may include, but is not limited to, at least one of: a time when the item is created, a time when the item is due, and a time when the item is finished.

It should be noted that the item information in the second state is sorted and displayed based on the second time information, so that the item information in the second state can be displayed orderly. Therefore, the efficiency for the user to obtain the item information in the second state can be improved.

In some embodiments, the method may further include: displaying, in response to detection of a trigger operation on the displayed item information, a document page recording the item information.

It can be understood that, in step 101, the execution subject acquires the item information from the document. The execution subject may store the correspondence between the item information and the document recording the item information.

Here, the document page may be displayed in response to a trigger operation on the item information.

Therefore, when the user wants to view the details about the item information, the document page recording the item information can be displayed quickly, which improves the efficiency of information display and the efficiency of information acquisition by the user.

In some embodiments, the method may further include at least one of but not limited to: jumping to a location where the item information is recorded on the document page to display the item information; and displaying the item information in a predefined display manner.

Here, the location where the item information (targeted by the trigger operation) is recorded in the document page is jumped to while displaying the document page, so as to display the item information.

In this way, when the user triggers the item information to display the document page, a desired position at which the item information is possibly displayed can be quickly jumped to, preventing the user from manually turning pages in the document page in order to find the location of the item information. Therefore, the speed at which the user obtains the context-related information of the item information in the document is improved.

Here, details about the predefined display manner depend on actual application scenarios, and thus are not limited herein.

For example, the item information in the document is highlighted.

For example, the item information in the document is displayed in a bold and color-changing font.

In this way, the item information in the document page can be displayed intuitively, so that the user can quickly locate the item information desired to be viewed in the document. It is unnecessary for the user to search for the item information desired to be viewed on the page, improving the efficiency for the user to obtain information.

In some embodiments, the displaying, in response to detection of a trigger operation on the displayed item information, a document page recording the item information may include: displaying a permission application interface in response to a fact that the target user does not have access to the document recording the triggered item information; sending a permission application request based on an operation on the permission application interface by the user; and displaying, in response to determination that the target user has obtained the access to the document based on the permission application request, the document recording the triggered item information.

For example, item information B created by Zhang San in a document A is to be executed by Li Si. However, Li Si may not have access to the document A. The item information display interface of Li Si displays the item information B. In response to that Li Si triggers the item information B to view the details, the permission application interface is provided to Li Si if he does not have access to the document A. Then, Li Si operates in the permission application interface to send a permission application request. After the permission application request is approved by a relevant user (for example, the owner of the document A), Li Si may obtain the access to the document A. When it is determined that Li Si has the access to the document A, the document A recording the item information B is displayed to Li Si.

It should be noted that by displaying the permission application interface, the target user can be provided with a way to quickly obtain the access. In this way, the speed of displaying the document recording the item information to the target user can be accelerated, and the speed of information acquisition by the user can be accelerated.

In some embodiments, the displaying, in response to detection of a trigger operation on the displayed item information, a document page recording the item information may include: displaying, in response to the detection of the trigger operation on the displayed item information, the document page recording the item information and a display area for displaying the item information together.

In other words, the display area for displaying the item information is constantly displayed before and after the trigger operation on the item information.

In this way, the item information is still displayed in the display area while displaying the document page recording the item information, which is convenient for the user to compare the item information and the document page. In addition, the users can conveniently and quickly view multiple desired document pages in the display area.

In some embodiments, the method further includes: moving, in response to detection of a state switch operation on item information, the item information targeted by the state switch operation to a display area corresponding to a state indicated by the state switch operation.

Here, the state switch operation may indicate to switch the item information from one state to another state.

For example, the state switch operation may switch the item information from the first state to the second state. In this case, the state switch operation indicates that the state to be switched to is the second state. Then, the item information targeted by the state switch operation is moved from the first display area (corresponding to the first state) to the second display area (corresponding to the second state).

It should be noted that, the position where the item information is displayed is changed in response to the state switch operation. Therefore, after the user switches the state of the item information, the item information can be quickly displayed in the display area corresponding to the state to be switched to, thereby improving the accuracy of the displayed information. It is convenient for the user to find information in a desired state based on the position where the information is displayed.

In some embodiments, the method further includes at least one of but not limited to: switching, in response to detection of a state switch operation on item information, a state of the item information in the document recording the item information; and switching a state of the item information in an application program that has acquired the item information.

Here, if the user switches the state of the displayed item information, then the switched state may be synchronized to the document recording the document information or synchronized to the application program that has obtained the item information.

Here, the state switch operation is an operation indicating to switch the state of the item information.

For example, the state switch operation switches the item information from the first state to the second state.

In some application scenarios, the details about the state switch operation depend on the actual application scenarios. For example, a state switch control associated with the item information may be set. The user operates the state switch control to switch the state of the item information.

Here, the application program that acquires the item information may be any application program that displays the item information. For example, the item information may be displayed in a calendar-related application. The user may view the item information through the calendar-related application. In this case, the calendar-related application may be understood as the application program that acquires the item information.

It should be noted that the state switched by the state switch operation performed in the display area can be quickly synchronized to the document recording the item information and the application program that has acquired the item information. In this way, the state of the item information in various places can be quickly synchronized, and the accuracy of the state of the item information can be improved.

In some embodiments, the method further includes: switching, in response to detection of a state switch operation on the item information recorded in the document page, a state of the item information in the display area where the item information is displayed.

Here, the state switch operation performed on the document page can be quickly synchronized to the item information displayed in the display area. In this way, the states of the item information displayed on document page and in the display area can be consistent. Therefore, accurate state information of the item information can be provided to the user.

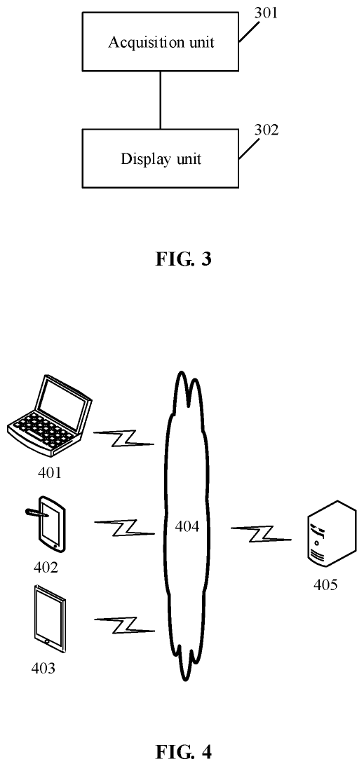

Referring to FIG. 3, an apparatus for displaying information is provided according to an embodiment of the present disclosure, as an implementation of the method shown in the above figures. The apparatus embodiment corresponds to the method embodiment shown in FIG. 1. The apparatus is applicable to various electronic devices.

As shown in FIG. 3, the apparatus for displaying information in this embodiment includes an acquisition unit 301 and a display unit 302. The acquisition unit is configured to acquire item information of a target user from at least one document. The item information of the target user includes an item for which the target user is the creator and/or executor. The display unit is configured to display the acquired item information on an associated page of a current page of the document or in a preset area on a current page.

In this embodiment, the specific processing of the recording unit 901, the detecting unit, and the sending unit 903 of the apparatus for displaying information and the technical effects brought about by them may refer to the steps 101, 102, and 103 in the embodiment in FIG. 1, respectively. Relevant descriptions are not repeated here.

In some embodiments, the acquiring the item information of the target user from the at least one document includes: determining, in response to detection of a first item creation operation performed by the target user in the document, item information created through the first item creation operation as the item information of the target user.

In some embodiments, the acquiring the item information of the target user from the at least one document includes: determining, in response to detection of a second item creation operation with the target user as the executor in the document, item information created through the second item creation operation as the item information of the target user.

In some embodiments, the acquiring the item information of the target user from the at least one document includes: searching for the item information of the target user from item information recorded in a document to be searched, where the document to be searched includes at least one of a text document and a table document, and the item information recorded in the document to be searched includes at least one of item information recorded in text of the text document, item information recorded in a table inserted in the text document, and item information recorded in a cell of the table document; and acquiring the found item information of the target user.

In some embodiments, the associated page includes a page for displaying document access information of the target user. The displaying the acquired item information on the associated page or the current page of the document may include: displaying the acquired item information on the page for displaying the document access information of the target user.

In some embodiments, the displaying the acquired item information includes: determining due item information that expires within a preset time period according to an item deadline and a current time; and indicating the due item information among the displayed item information by predefined indication information.

In some embodiments, the apparatus is further configured to: display, in response to a document access operation, a page of the document indicated by the document access operation; acquire item information of the document indicated by the document access operation, where the item information includes an item for which any user is the executor and/or creator; and display the item information of the document indicated by the document access operation on a current page of the accessed document.

In some embodiments, the displaying the acquired item information includes at least one of: displaying item information in a first state in a first display area; and displaying item information in a second state in a second display area.

In some embodiments, an order in which the item information is displayed in the first display area may be determined through a first order determination step. The first order determination step may include: determining, based on first time information associated with the item information in the first state, an order in which the item information in the first state is to be displayed.

In some embodiments, content indicated by the first time information includes at least one of a null value or a time point. The determining, based on the first time information associated with the item information in the first state, the order in which the item information in the first state is to be displayed includes: determining, based on the content indicated by the first time information, a category that the item information in the first state falls into, where the category that the item information in the first state falls into includes at least one of: a null category and a time point category; generating a queue of the item information in the first state; and determining, based on the queue of the item information in the first state, the order in which the item information in the first state is to be displayed. In the queue of the item information in the first state, the item information of the time point category in the first state is ranked before the item information of the null category in the first state.

In some embodiments, the generating a queue of the item information in the first state includes: determining, based on a time point indicated by the first time information associated with the item information in the first state, a ranking of the item information of the time point category in the queue of the item information.

In some embodiments, the order in which the item information in the second state is to be displayed in the second display area is determined through a second order determination step. The second order determination step may include: determining, based on second time information associated with the item information in the second state, the order in which the item information in the second state is to be displayed.

In some embodiments, the apparatus is further configured to: display, in response to detection of a trigger operation on the displayed item information, a document page recording the item information.

In some embodiments, the apparatus is further configured to perform at least one of: jumping to a location where the item information is recorded on the document page to display the item information; and displaying the item information in a predefined display manner.

In some embodiments, the displaying, in response to detection of a trigger operation on the displayed item information, a document page recording the item information may include: displaying a permission application interface in response to a fact that the target user does not have access to the document recording the triggered item information; sending a permission application request based on an operation performed on the permission application interface by the target user; and displaying, in response to determination that the target user has obtained the access to the document based on the permission application request, the document recording the triggered item information.

In some embodiments, the displaying, in response to detection of a trigger operation on the displayed item information, a document page recording the item information may include: displaying, in response to the detection of the trigger operation on the displayed item information, the document page recording the item information and a display area for displaying the item information together.

In some embodiments, the apparatus is further configured to: move, in response to detection of a state switch operation on item information, the item information targeted by the state switch operation to a display area corresponding to a state indicated by the state switch operation.

In some embodiments, the apparatus is further configured to: switch, in response to detection of a state switch operation on item information, a state of the item information in the document recording the item information; and/or switch a state of the item information in an application program that has acquired the item information.

In some embodiments, the apparatus is further configured to: switch, in response to detection of a state switch operation on item information recorded in the document page, a state of the item information in a display area where the item information is displayed.

Reference is made to FIG. 4, which is a schematic structural diagram of a system architecture to which the method for displaying information according to the embodiment of the present disclosure is applicable.

As shown in FIG. 4, the system architecture may include terminal devices 401, 402 and 403, a network 404, and a server 405. The network 404 is configured as a medium for providing communication links between the terminal devices 401, 402 and 403 and the server 405. The network 404 may include various connection types, such as wired communication links, wireless communication links, or fiber optic cables.

The terminal devices 401, 402 and 403 interact with the server 405 through the network 404 to receive or send messages and the like. Various client applications, such as web browser applications, search applications, and news information applications, may be installed on the terminal devices 401, 402 and 403. The client applications in the terminal devices 401, 402 and 403 receive user instructions and implement corresponding functions according to the user instructions, e.g., adding information according to the user instructions.

The terminal devices 401, 402 and 403 may be hardware or software. In the case of hardware, the terminal devices 401, 402 and 403 may be various electronic devices with display screens and supporting web browsing, including but not limited to smartphones, tablet computers, e-book readers, MP3 players (moving picture experts group audio layer III), MP4 players (moving picture experts group audio layer IV), laptop portable computers, desktop computers and the like. In the case of software, the terminal devices 401, 402 and 403 may be installed in the electronic devices listed above. The terminal devices 401, 402 and 403 may be implemented as multiple software or software modules (for example, software or software modules for providing distributed services), or may be implemented as a single software or software module, which are not limited herein.

The server 405 may be a server that provides various services, such as receiving information acquisition requests sent by the terminal devices 401, 402 and 403, acquiring display information corresponding to the information acquisition requests in various ways according to the information acquisition requests, and sending relevant data of the display information to the terminal devices 401, 402 and 403.

It should be noted that the method for displaying information according to the embodiments of the present disclosure may be performed by a terminal device. Correspondingly, the apparatus for displaying information may be arranged in the terminal devices 401, 402 and 403. In addition, the method for displaying information according to the embodiments of the present disclosure also be performed by the server 405. Correspondingly, the apparatus for displaying information may be arranged in the server 405.

It should be understood that the number of terminal devices, the number of networks and the number of servers in FIG. 4 are only illustrative. The system architecture may include the terminal devices in any number, networks in any number and servers in any number, as needed.

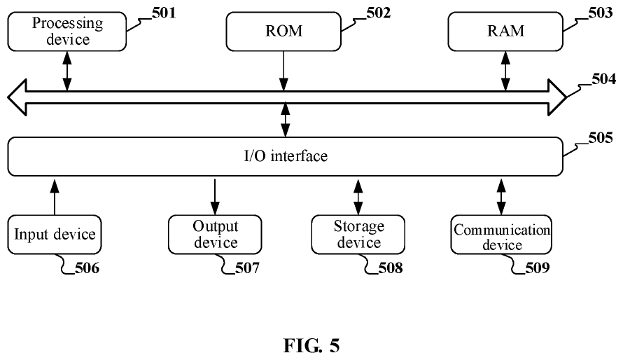

Reference is made to FIG. 5, which is a schematic structural diagram of an electronic device (e.g., the terminal device or server in FIG. 4) suitable for implementing the embodiments of the present disclosure. The terminal device in the embodiments of the present disclosure may include but not limited to mobile terminals such as mobile phones, notebook computers, digital broadcast receivers, PDAs (personal digital assistants), PADs (tablet computers), PMPs (portable multimedia players) and vehicle terminals (such as car navigation terminals); and fixed terminals such as digital TVs and desktop computers. The electronic device shown in FIG. 5 is only an example, and should not limit the functions and application scope of the embodiments of the present disclosure.

As shown in FIG. 5, the electronic device 500 may include a processing device (such as a central processing unit and a graphics processing unit) 501. The processing device 501 can execute various appropriate actions and processes according to programs stored in a read only memory (ROM) 502 or loaded from a storage device 508 into a random-access memory (RAM) 503. In the RAM 503, various programs and data necessary for the operation of the electronic device 500 are also stored. The processing device 501, the ROM 502 and the RAM 503 are connected to each other through a bus 504. An input/output (I/O) interface 505 is also connected to the bus 504.

Generally, the following devices may be connected to the I/O interface 505: input devices 506 including, for example, a touch screen, a touch pad, a keyboard, a mouse, a camera, a microphone, an accelerometer, a gyroscope, etc.; output devices 507 including, for example, a liquid crystal display (LCD), a speaker, a vibrator, etc.; a storage device 508 including, for example, a magnetic tape, a hard disk, etc.; and a communication device 509. The communication device 509 may allow the electronic device 500 to perform wireless or wired communication with other devices to exchange data. Although FIG. 5 shows the electronic device 500 having various devices, it should be understood that implementing or having all of the devices shown is not a requirement. More or fewer devices may alternatively be implemented or provided.

In particular, according to an embodiment of the present disclosure, the processes described above with reference to the flowcharts may be implemented as computer software programs. For example, embodiments of the present disclosure include a computer program product. The computer program product includes a computer program carried on a non-transitory computer-readable medium. The computer program contains program code for carrying out the methods shown in the flowcharts. In such an embodiment, the computer program may be downloaded and installed from a network via the communication device 509, or from the storage device 508, or from the ROM 502. When the computer program is executed by the processing device 501, the functions defined in the methods of the embodiments of the present disclosure are performed.

It should be noted that the above computer-readable medium in the present disclosure may be a computer-readable signal medium or a computer-readable storage medium or any combination of the above two. The computer readable storage medium may be, for example, but not limited to, an electrical, magnetic, optical, electromagnetic, infrared, or semiconductor system, apparatus, or device, or any combination thereof. More specific examples of the computer-readable storage medium may include, but are not limited to: electrical connections with one or more wires, portable computer disks, hard disks, a random-access memory (RAM), a read only memory (ROM), an erasable programmable read-only memory (EPROM or Flash), optical fibers, a compact disk read-only memory (CD-ROM), optical storage devices, magnetic memory components, or any suitable combination of the above. In the present disclosure, the computer-readable storage medium may be any tangible medium that contains or stores a program. The program may be used by or in conjunction with the instruction execution system, apparatus or device. In the present disclosure, however, the computer-readable signal medium may include a data signal propagated in baseband or as part of a carrier wave, and the data signal carries computer-readable program code. Such propagated data signals may be in various forms, including but not limited to electromagnetic signals, optical signals, or any suitable combination of the foregoing. The computer-readable signal medium can also be any computer-readable medium other than the computer-readable storage medium. The computer-readable signal medium may transmit, propagate, or transport a program for use by or in connection with an instruction execution system, apparatus, or device. Program code embodied on the computer-readable medium may be transmitted by any appropriate medium, including but not limited to: wires, optical cables, RF (radio frequency), etc., or any suitable combination of the above.

In some embodiments, a client may communicate with a server using any currently known or future-developed network protocols such as HTTP (Hypertext Transfer Protocol), and the client and the server may be interconnected with digital data communication (e.g., a communication network) of any form or medium. Examples of the communication network include local area networks (“LANs”), wide area networks (“WANs”), internetworks (e.g., the Internet), and peer-to-peer networks (e.g., ad hoc peer-to-peer networks), as well as any currently known or future developed network.

The computer-readable medium may be included in the electronic device, or may exist independently without being incorporated into the electronic device.

The computer-readable medium carries one or more programs that, when being executed by the electronic device, cause the electronic device to: acquire item information of a target user from at least one document, where the item information of the target user includes an item for which the target user is a creator and/or executor; and display the acquired item information on an associated page of the document or on a current page.

The computer program code for carrying out operations of the present disclosure may be written in one or more programming languages, or a combination thereof. Such programming languages include, but are not limited to, object-oriented programming languages such as Java, Smalltalk, C++, and conventional procedural programming languages such as the “C” language or similar programming languages. The program code may be executed entirely on the user computer, partly on the user computer, as a stand-alone software package, partly on the user computer and partly on a remote computer, or entirely on a remote computer or server. Where a remote computer is involved, the remote computer may be connected to the user computer through any kind of network including a local area network (LAN) or a wide area network (WAN), or may be connected to an external computer (e.g., via the Internet by an Internet service provider).

The flowcharts and block diagrams in the drawings illustrate the architecture, functionality, and operation of possible implementations of systems, methods and computer program products according to various embodiments of the present disclosure. In this regard, each block in the flowchart or block diagram may represent a module, program segment, or portion of code. The module, program segment, or portion of code contains one or more executable instructions for implementing specified logical functions. It should also be noted that, in some alternative implementations, the functions noted in the blocks may occur in an order different form the order noted in the drawings. For example, two blocks shown in succession could, in fact, be executed substantially concurrently or in a reverse order, depending upon the functionality involved. Further, each block in the block diagrams and/or flow charts, and a combination of blocks in the block diagrams and/or flow diagrams may be performed by a dedicated hardware-based system that performs the specified functions or operations or by a combination of dedicated hardware and computer instructions.

The units involved in the embodiments described in the present disclosure may be implemented by software or by hardware. The name of a unit does not in any way constitute a qualification of the unit itself. For example, the acquisition unit may also be described as “a unit for acquiring item information of a target user”.

The functions described herein above may be performed at least in part by one or more hardware logic components. For example, without limitation, exemplary hardware logic components that may be used include: field programmable gate arrays (FPGAs), application specific integrated circuits (ASICs), application specific standard products (ASSPs), system on chips (SOCs), complex programmable logical devices (CPLDs), etc.

In the context of the present disclosure, the machine-readable medium may be a tangible medium that may contain or store a program for use by or in conjunction with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, apparatus, or devices, or any suitable combination of the foregoing. More specific examples of the machine-readable storage medium may include one or more wire-based electrical connections, portable computer disks, hard disks, a random-access memory (RAM), a read only memory (ROM), an erasable programmable read only memory (EPROM or flash memory), fiber optics, a compact disk read-only memory (CD-ROM), optical storage devices, magnetic storage devices, or any suitable combination of the foregoing.

Only preferred embodiments of the present disclosure and an illustration of the applied technical principle are described above. Those skilled in the art should understand that, the scope of the present disclosure is not limited to the technical solution formed by specific combinations of the above technical features, but also covers other technical solutions formed by any combination of the above technical features or their equivalent features without departing from the above disclosed concept, for example, a technical solution formed by replacing the above features with technical features with similar functions disclosed in (but not limited to) the present disclosure.

In addition, although operations are described in a particular order, it should not be understood that the operations are necessarily performed in the particular order shown or performed in sequential order. Under certain circumstances, multitasking and parallel processing may be advantageous. Likewise, although the above discussion contains several specific implementation details, these should not be construed as limitations on the scope of the present disclosure. Certain features that are described in context of separate embodiments may also be implemented in combination in a single embodiment. Alternatively, various features that are described in the context of a single embodiment may also be implemented in multiple embodiments separately or in any suitable sub-combination.

Although the subject matter has been described in language specific to structural features and/or methodological acts, it should be understood that the subject matter defined in the appended claims is not necessarily limited to the specific features or acts described above. Instead, the specific features and acts described above are merely example forms of implementing the claims.

1-22. (canceled)

23. A method for displaying information, comprising:
acquiring item information of a target user from at least one document, wherein the item information of the target user comprises an item for which the target user is a creator and/or executor; and
displaying the acquired item information on an associated page of a current page of the document or in a preset area on a current page.

24. The method according to claim 23, wherein acquiring item information of a target user from at least one document comprises:
determining, in response to detection of a first item creation operation performed by the target user in the document, item information created through the first item creation operation as the item information of the target user; or,
determining, in response to detection of a second item creation operation with the target user as the executor in the document, item information created through the second item creation operation as the item information of the target user; or,
searching for the item information of the target user from item information recorded in a document to be searched, wherein the document to be searched comprises at least one of a text document and a table document, and the item information recorded in the document to be searched comprises at least one of item information recorded in text of the text document, item information recorded in a table inserted in the text document, and item information recorded in a cell of the table document; and acquiring the item information of the target user found from the search.

25. The method according to claim 23, wherein the associated page comprises a page for displaying document access information of the target user, wherein
the displaying the acquired item information on an associated page of a current page of the document or in a preset area on a current page comprises: displaying the acquired item information on the page for displaying the document access information of the target user.

26. The method according to claim 23, wherein the displaying the acquired item information comprises:
determining due item information that expires within a preset time period according to an item deadline and a current time; and
indicating the due item information among the displayed item information by predefined indication information.

27. The method according to claim 23, further comprising:
displaying, in response to a document access operation, a page of the document indicated by the document access operation;
acquiring item information of the document indicated by the document access operation, wherein the item information comprises an item executed and/or created by any user; and
displaying the item information of the document indicated by the document access operation on a current page of the accessed document.

28. The method according to claim 26, wherein the displaying the acquired item information comprises at least one of:
displaying item information in a first state in a first display area; and
displaying item information in a second state in a second display area.

29. The method according to claim 28, wherein an order in which the item information is displayed in the first display area is determined through a first order determination step, and the first order determination step comprises:
determining, based on first time information associated with the item information in the first state, an order in which the item information in the first state is to be displayed.

30. The method according to claim 29, wherein content indicated by the first time information comprises at least one of: a null value or a time point, wherein the determining, based on the first time information associated with the item information in the first state, the order in which the item information in the first state is to be displayed comprises:
determining, based on the content indicated by the first time information, a category that the item information in the first state falls into, wherein the category that the item information in the first state falls into comprises at least one of: a null category and a time point category;
generating a queue of the item information in the first state; and
determining, based on the queue of the item information in the first state, the order in which the item information in the first state is to be displayed, wherein in the queue of the item information in the first state, the item information of the time point category in the first state is ranked before the item information of the null category in the first state.

31. The method according to claim 30, wherein the generating a queue of the item information in the first state comprises:
determining, based on a time point indicated by the first time information associated with the item information in the first state, a ranking of the item information of the time point category in the first state in the queue of the item information in the first state.

32. The method according to claim 28, wherein an order in which the item information in the second state is to be displayed in the second display area is determined through a second order determination step, and the second order determination step comprises:
determining, based on second time information associated with the item information in the second state, the order in which the item information in the second state is to be displayed.

33. The method according to claim 1, further comprising:
displaying, in response to detection of a trigger operation on the displayed item information, a document page recording the item information.

34. The method according to claim 33, further comprising at least one of:
jumping to a location where the item information is recorded on the document page to display the item information; and
displaying the item information in a predefined display manner.

35. The method according to claim 33, wherein the displaying, in response to detection of a trigger operation on the displayed item information, a document page recording the item information comprises:
displaying a permission application interface in response to a fact that the target user does not have access to the document recording the triggered item information;
sending a permission application request based on an operation performed on the permission application interface by the target user; and
displaying, in response to determination that the target user has obtained the access to the document based on the permission application request, the document recording the triggered item information.

36. The method according to claim 33, wherein displaying, in response to detection of a trigger operation on the displayed item information, a document page recording the item information comprises:
displaying, in response to the detection of the trigger operation on the displayed item information, the document page recording the item information and a display area for displaying the item information together.

37. The method according to claim 23, further comprising:
moving, in response to detection of a state switch operation on the item information, the item information targeted by the state switch operation to a display area corresponding to a state indicated by the state switch operation; or,
switching, in response to detection of a state switch operation on the item information, a state of the item information in the document recording the item information; and/or
switching a state of the item information in an application program that has acquired the item information; or,
switching, in response to detection of a state switch operation on item information recorded in a document page, a state of corresponding item information in a display area where the item information is displayed.

38. An apparatus for displaying information, comprising:
at least one processor; and
at least one memory communicatively coupled to the at least one processor and storing instructions that upon execution by the at least one processor cause the apparatus to:
acquire item information of a target user from at least one document, wherein the item information of the target user comprises an item for which the target user is a creator and/or executor; and
display the acquired item information on an associated page of a current page of the document or in a preset area on a current page.

39. A computer-readable medium, storing a computer program that, when being executed by a processor, implements the method according to claim 23.
